(19) United States
(12) Patent Application Publication
(10) Pub. No.: US 2002/0050983 A1
(43) Pub. Date: May 2, 2002

(54) Method and apparatus for a touch sensitive system employing spread spectrum technology for the operation of one or more input devices

(76) Inventors: Qianjun Liu, Toronto (CA); Denny Jaeger, Oakland, CA (US)

Correspondence Address: Harris Zimmerman, Law Offices of Harris Zimmerman, Suite 710, 1330 Broadway, Oakland, CA, 94612-2506, US

(21) Appl. No.: 09/877,611

(22) Filed: Jun. 8, 2001

Related U.S. Application Data
(63) Continuation-in-part of application No. 09/670,610, filed on Sep. 26, 2000.

(51) Int. Cl. G09G 5/00

(52) U.S. Cl. 345/173

(57) ABSTRACT

A touch sensing apparatus for receiving input from one or more touch stimulating devices employs a spread spectrum signaling arrangement to transmit signals from the touch stimulating devices for identification and location determination. Spread spectrum techniques may include DSSS, FHSS, THSS, chirp, or combinations thereof. Passive devices operate in the propagation medium of an energy field formed of acoustic, EM, or light waves and reflect signals to signal pickups, where RSS or time delay techniques are used to determine location and spread spectrum encoding is used to identify the devices. Active devices generate a touch stimulating signal that is spread spectrum encoded for identification, and signal pickups in a propagation medium receive the touch stimulation signals which are identified by the SS encoding and located using RSS or time-delay techniques.

### REFERENCE TO RELATED APPLICATION

This application is a continuation-in-part of application Ser. No. 09/670,620, filed Sep. 26, 2000, for which priority is claimed.

### BACKGROUND OF THE INVENTION

This invention relates to an apparatus and method employing Spread Spectrum (SS) signal structures for the operation of one or more touch-input devices on a touch-sensing system.

A touch system consists of two parts, namely one or more touch-input devices and a touch-sensing architecture. These two parts themselves can consist of hardware and/or software structures to realize their functionality.

In this document, a touch-sensing tablet (termed touch screen hereafter) can be regarded as a touch screen, a digitizer, a writing panel, a modified mouse pad, or the like. A touch-input device can be regarded as a human finger, a stylus, a pen, a rotary knob, a mouse, a slider (fader), and the like. The system operation is defined as, but not limited to, one or any possible combination of the following functionalities, namely a touch screen (or its equivalent) that identifies, tracks, or communicates with one or more touch-input devices.

Touch screen technologies known in the prior art are most easily differentiated according to their system infrastructures. They are traditionally classified into resistive, or pressure sensing; capacitive; surface acoustic wave; ultrasound; and electromagnetic (EM) wave systems.

In resistive systems, the touch screen surface is covered by two parallel pressure sensitive layers, consisting of a conductive layer and a resistive layer which are spaced apart without contact. A driving voltage is applied to the layers. The pressure of a touch on the screen causes the two layers to contact at the touch point, and draws currents from the touch screen assembly. The current draws are sensed and then used to calculate the position of the touch point. Resistive systems are low cost, with acceptable durability of the touch screen surface, but the resistive layer in particular diminishes screen clarity.

In capacitive systems, the screen assembly includes a sensing layer that is capable of storing electrical charges. Electrodes located at the boundaries of the touch screen apply an electrical field that is distributed across the touch screen surface, forming, in effect, a distributed capacitor. In a passive touch, a human finger or a conductive device touches the screen and draws a current from the electrodes. The differential in the current flows in the boundary electrodes corresponds to the position of the touch on the screen. For this reason, passive capacitive touch screens do not work well, if at all, when used with a non-conductive device, such as a gloved hand or an inert stylus. In an active capacitive system, an active device emits an excitation signal at the touch point, injecting current into the electrodes, and the current is measured to determine the touch position. Active capacitive systems usually have an improved touch resolution over passive system, due to the fact that an active device provides an improved Signal-to-Noise Ratio (SNR) compared to passive systems. Capacitive systems are very durable, with high screen clarity.

Surface acoustic wave systems employ transducers and reflectors placed at the screen periphery to establish a field of acoustic surface waves on the touch screen. A finger or stylus or any acoustic absorbing material is placed in the field to introduce the touch event. Measurements of this field change are used to calculate the touch position. This technique requires no coating or special layer, so that the durability of the assembly is dependent on the glass of the screen itself. However, the screen surface must remain clean in order for the acoustic wave field to be established.

Ultrasound systems can be classified into active and passive systems. In passive systems, a transmitter is used in the touch screen to transmit an ultrasound (acoustic) signal across the screen surface. This signal is reflected by the device and received by the receivers of the touch screen assembly. In an active system, the device emits an excitation ultrasound signal, which is received by the receivers of the touch screen. In both passive and active systems, the propagation delays of the received signals are usually used to calculate the position of the pointing device. This positioning technology may be termed the time-delay method. In ultrasound systems, no additional special screen layer is required, and resolution may be quite high. But the touch resolution may be subject to interference from ambient noise and multi-path propagation of the ultrasound. Also, in passive systems, objects with poor ultrasound reflectivity cannot be used as the input devices.

Similar to ultrasound technology, EM wave systems can also be classified into passive and active systems. The major difference between ultrasound and EM wave systems is that EM wave systems employ an EM signal instead of an ultrasound signal. Due to the fact that EM signals propagates at a speed of 300 million meters per second, EM wave systems generally feature a position sensing arrangement based on Received Signal Strengths (RSSs), rather than propagation time-delays used in typical ultrasound systems.

In the prior art, the number of touch-input device allowed in a touch system is generally limited to one. However, in U.S. Pat. Nos. 6,005,555, 6,020,849, and other similar patents, methods of operating multiple touch-input devices are addressed, with each device designed to work on single or multiple narrowband channels.

Concerning information encoding, U.S. Pat. No. 5,247,138 describes a cordless digitizer stylus that transmits encoded signal to a touch-sensing tablet. This signal contains information bits relating to the touch-input device such as on-off status of the switches, position of the device, etc. These information bits are coded by a binary code at a particular frequency, and the information carrying signal disclosed is a narrowband signal.

In U.S. Pat. No. 6,005,555, a touch system with two carrier frequencies f₀ and f₁ is disclosed. Information bits of the system are commands from the touch-sensing tablet to the touch-input devices and data bits from the devices to the tablet. The system signal spectrum consists of two discrete information spectra, centered at two carrier frequencies f₀ and f₁. No signal with bandwidth wider than the information bandwidth is used. Similar disclosures can be found in other patents regarding touch screens.

It should be emphasized that touch systems of the prior art, including the above mentioned patents, are regarded as narrowband systems. That is, these systems have their signal bandwidth at no wider than the information bandwidth, as shown in FIG. 1A. There is no wideband encoding for the system information bits or carriers in these patent disclosures.

In summary, the signal spectra of the above mentioned narrowband systems are the combination of the discrete information spectra at individual carrier frequencies. Their signal energy is confined within these discrete information spectra. No extra bandwidth other than the information spectra is occupied. These narrowband systems are significantly different from wideband systems, namely spread spectrum (SS) systems, of this invention.

### SUMMARY OF THE INVENTION

The invention generally comprises a method and apparatus for a touch system employing SS signal structure for the use of one or more touch-input devices on a touch-sensing surface. The invention permits the touch system to be able to simultaneously identify, track, communicate with, etc., one or a plurality of touch-input devices.

This section is organized as follows: Section 3.1 gives some basic concepts and terminology, as well as the associated advantages of the SS touch system used in this invention; Section 3.2 defines and discuses the specific SS signals used by this invention; Section 3.3 addresses some important system designing aspects of how to implement the SS touch systems this invention. Section 3.4 gives the whole SS touch system configuration.

3.1 Spread Spectrum Touch Systems

In this invention, a signal is defined to be the electronic records, e.g., a sequence of time domain amplitudes of the vibration of an energy field. In a touch system of this invention one or more information embedded energy field(s) may be used as the physical carrier(s) for transmitting (TX) and receiving (RX) the system information. These activities are carried out and confined within one or more communication channels, for which the spectra are allocated beforehand by system design and characterized by their bandwidths and spectral locations. A touch system may have multiple concurrent communication channels, assigned at different spectral locations without overlapping.

In a touch system, concerning one communication channel, information spectrum and signal spectrum are defined as the spectral allocations for the information and the vibration of the energy field, respectively. Therefore, the following relationship can be established:

BW_{lnfo}≦BW_{Sig}≦BW_{Ch} (1)

where BW_{Info}, BW_{Sig}, and BW_{Ch} are the bandwidths of information, signal, and communication channel, respectively. In this invention, a system is called wideband if it has at least one communication channel such that the signal bandwidth is wider than the information bandwidth, as seen from the FIG. 1B. It is well known in the art that this system is also called a SS system, in the sense that at this channel the information spectrum is spread to a signal spectrum with wider bandwidth. This process of spectral spreading is accomplished by, e.g., coding the information bits or the carrier frequency with one or more wideband codes having continuous bandwidths. The inverse of this procedure is usually called despreading (matched-filtering or correlating).

In a touch system of this invention the spreading is done at the transmission end using wideband code(s), so the signal used for transmission is a wideband signal. At the reception end, this wideband signal is despread with the same code(s) to get the information bits back.

There are two major advantages of using SS for touch systems in this invention, namely to improve SNR and to reduce multi-path propagation.

3.1.1 SNR Improvement

It is well known that in a SS system, when the information bandwidth is evenly spread, the system Processing Gain (PG) can be expressed as:

$$PG ( dB ) = 10 log 10 ( \frac{{BW}_{Sig}}{{BW}_{Info}} ) . \qquad ( 2 )$$

Having the PG, the SNR of the SS system can be improved to

SNR_{SS}=PG+SNR_{Sig}, (3)

where SNR_{SS} and SNR_{Sig} are the SNRs of a SS touch system and the transmitted signal respectively.

With improved SNR, SS systems in this invention can be designed in ways that are very different from narrow band touch systems. The benefits of having improved SNR in a SS system include:

SS systems can have higher noise immunity.

Touch-input devices can be cost-effectively designed to have balanced noise immunity through spreading.

Signals can be transmitted with less energy.

Signals can propagate for longer distance.

The power consumption of each touch-input device can be greatly reduced so that various power supply methods, which are impractical in some cases for narrowband devices, can be used.

Passive touch-input devices can be widely introduced.

Higher touch resolution can be easily achieved.

For example, for a SS system with SNR_{Sig}=−10 dB (signal energy is 10-times less than noise) and PG=30 dB (signal bandwidth is 1000-times wider than information bandwidth), its SNR_{SS}=20 dB. That is to say, with a properly designed PG, the SS system can pick up information from signals below noise. A narrowband system can not work on an environment that has negative SNR, unless some additional signal processing methods, e.g. signal averaging, are used.

3.1.2 Multi-path Reduction

Multi-path propagation is a phenomenon that occurs, for example, if there are reflectors, obstacles, and boundaries, etc., in the propagation medium. A receiver in the wave field will receive not only a signal from a signal source through a direct propagating path, but it will also receive signals (called multi-path signals) reflected from these objects. Multi-path signals are always delayed as compared to direct-path signals. In fact, multi-path signals can severely degrade the system's performance if they are not separated from the direct-path signal.

In a SS system, Δt, the width of the main lobe of correlation function after despreading, can be written as:

$$Δ t = \frac{1}{{BW}_{code}} , \qquad ( 4 )$$

where BW_{code} is the bandwidth of the SS code used for despreading. Δt can be regared as the ability of a SS system to resolve multi-path signals from their direct-path signal after despreading.

The following is an example showing that the multi-path problem can be eliminated by the present invention. Given: an ultrasound signal is propagating through the air at an approximate speed of sound Vs=330 m/s and BW_{code}=1 MHz, then Δd, the minimum distance between a direct-path signal and the multi-path signals that a SS system is able to resolve, becomes:

$$Δ d = Δ t \times {V}_{s} = \frac{{V}_{S}}{{BW}_{code}} = \frac{330}{1 , 000 , 000} = 0.33 mm \qquad ( 5 )$$

That is to say, any multi-path signal that is 0.33 mm away from the direct-path signal can be removed. This is very difficult to achieve in narrowband systems.

3.2. Spread Spectrum Signals

In this invention, a variety of SS signals with different structures can be used. These signals include Direct Sequence Spread Spectrum (DSSS) signals, Frequency Hopping Spread Spectrum (FHSS) signals, Time Hopping Spread Spectrum (THSS) signals, Linear Frequency Sweeping (Chirp) signals,, Hybrid signals, and the like.

3.2.1 DSSS Signals

In this invention, a DSSS signal is generated by encoding the system information bits with one or more wideband codes, which occupy a given bandwidth. (These codes are called Direct Sequence (DS) codes.) By generating a signal in this way, the resulting signal bandwidth is the sum of the information bandwidth plus the bandwidth of the DS code. FIGS. 2A-2C are illustrations of aspects of DSSS signals.

One important and frequently used DS code is the Code Division Multiple Assess (CDMA) code. This invention allows one or a plurality of devices to be simultaneously operated within one channel. One way of doing this is to assign each device with a unique CDMA code, which is orthogonal to CDMA codes used by other devices.

The orthogonality of CDMA codes enables the information bits of one device to be easily distinguished from information bits of other devices, by matched-filtering the received signal with the individual CDMA code of each device. This matching procedure is analogous to identifying a person as being distinctly different from other persons according to the uniqueness of his (her) fingerprint or picture.

3.2.2 FHSS Signals

To generate a FHSS signal in this invention, the carrier frequency of the information bits, instead of information bits themselves (like in a DSSS signal), is encoded by a predefined frequency hopping table, which is similar to a DS code that has a given bandwidth. FIGS. 3A and 32B are illustrations of one possible hopping sequence before and after spreading. After the hopping procedure, the signal spectrum becomes wider.

3.2.3 THSS Signals

To generate a THSS signal in this invention, the information bits are first put into information packages that occupy a sequence of time slots. Then a time hopping table, similar to the frequency hopping table of FHSS signals, is used to encode the time instants that the information packages are sent out. FIG. 4 is an illustration of hopping the time slots of a THSS signal.

3.2.4 Chirp Signals

A Chirp signal is a frequency-modulated signal that has its instantaneous frequency going linearly from one frequency to another. If the instantaneous frequency increases in time, its called up-Chirp, otherwise it is called down-Chirp. FIG. 5A is an illustration of the waveform and FIG. 5B shows the instantaneous frequency of a up-Chirp signal. Chirp codes can be regarded as special DSSS codes, and SS signals obtained from spreading the information bits with Chirp codes are regarded as DSSS signals.

3.2.5 Hybrid Signals

A hybrid SS signal in this invention may be generated from using any one of the possible combinations of the signal generating methods defined in Sections 3.2.1-3.2.4. For instance, this can be done by first spreading the information bits within one channel using DSSS code, and then by hopping the DSSS signal across available channels.

One advantage of using hybrid SS signals in this invention is its relative low cost of implementation. For example, it is very easy to spread the information bandwidth 100-times wider using DSSS code and hop the DSSS signal to 10 channels to achieve a 30 dB PG, whereas it could be very costly to directly generate a DSSS signal with 30 dB PG using available prior art systems.

3.3. System Design Aspects

In this section some important implementation aspects of system design are addressed, which include the following issues:

1) Energy fields that carry the physical SS signals.

2) The mediums in which the energy field is propagating.

3) The active or passive ways that a touch-input device generates its SS signal.

4) The transducers that are used by the SS touch systems.

5) Mathematics models on which the system operation is based.

6) Methods for simultaneously operating a plurality of touch-input devices.

7) Power supply methods for the touch-input devices.

3.3.1 Energy Fields

An energy field is defined for this invention as a wave-propagating field that physically carries the SS signals with embedded information. In this invention three types of energy fields may be used: EM wave fields, acoustic wave fields, and light wave fields. Signals carried by different wave fields may be different types. For example, a Radio Frequency (RF) signal is generated by an EM field at a radio frequency, an ultrasound signal is generated by an acoustic field at a frequency higher that the perception of human hearing, an infrared (IR) signal is generated by an EM field at a frequency higher than the frequency spectrum of red light,etc.

In this invention a touch system may use more than one energy field to implement the system's operation. For example, a touch system may use an ultrasound signal to track the touch-input device and use an RF signal to communicate with this device.

3.3.2. Wave Propagating Medium

In this invention different types of materials may be used as the propagation mediums of the energy fields. For example, in a touch system an ultrasound signal can propagate through the air, or through a sound-conducting layer coated on the touch-sensing plane, to establish the system communication. Similarly, a RF signal can propagate through space or through a resistive layer coated on a touch-sensing plane to do the same job. Likewise, a light signal may propagate through space or through a light conducting layer for system communications.

3.3.3 Active and Passive Systems

A touch-input device is classified in this invention as active or passive in terms of the way(s) that it sends its information carrying signals to a touch-sensing tablet or plane. Namely, if the touch input device generates the signals by itself, it is an active device. If it only reflects signals sent from the touch-sensing plane, it is a passive device. One difference between an active and passive device in this invention is that inside the passive device there are no electrical components. A passive device is only a wave energy reflector, so it is very low cost, as compared to an active device.

In this invention, system operation may be implemented using either active or passive touch-input devices, depending on the practical system design considerations. For example, if the tracking accuracy and the system capacity (the number of simultaneous touch-input devices allowed) are of great importance, then active devices are good choices. If the cost and simplicity of the touch-input devices are of great importance, then passive devices should be considered.

A touch-input device in this invention may also be designed to be a hybrid type, that is, it can have some of its signals sent out in an active way and some in a passive way. For example, when used in a multiple-device environment, at the first time a touch-input device touches the touch-sensing surface, it needs, to report its identity very quickly. To accomplish this, it can actively send out a short burst of an identification signal. Subsequently, to enable this device's movements to be tracked, the device need only reflect the positioning signals from the touch-sensing surface. Thus no energy emanating from a source inside the device is needed for tracking. This approach enables the device to combine good functionality with minimum power consumption. Likewise, the system may be designed to use both spread spectrum and narrow band communications between the touch input devices and the touch sensing system, and vice versa.

3.3.4 Transducers

A receiver of this invention is defined as an electronic device that converts the energy of the wave field used in a touch system into electronic signals. For example, a microphone is a device that converts air vibration into electronic signals. Whereas, a transmitter is an electronic device that converts the electronic signals into the energy of a wave field. For example, a speaker is a device that converts electronic signals into sound. If a device can perform both functions, it is a transducer (RX/TX). Sometimes the term transducer is also used to represent either a transmitter or a receiver.

One important issue pertaining to this invention is the wideband characteristics of the transducers. Ideally the wideband response of a transducer in this invention should be essentially flat across the entire bandwidth. If it is not, then some calibration procedures can be used. One way of calibrating the system is to take some measurements regarding the performance of the transducers during system design, then store these measurements into memory to compensate for the transducers' response characteristics.

3.3.5 System Operating Models

In this invention different mathematics models are developed to describe the system operation, depending on the physical structures that a touch system is built upon. These models basically involve signal processing methods to estimate parameters like time-delays, RSSs, SNRs, etc, to perform a given system's operations.

3.3.5.1 Identification Models

When a touch system is designed to have only one touch-input device, the presence of that touch-input device can be easily identified from the its RSS, either in an active or a passive way.

When a plurality of touch-input devices is concerned, a method of Multiple Access (MA) is needed to identify different devices. The MA methods used in this invention include:

1) CDMA methods that allow MA to be performed within the same communication channel, by assigning each touch-input device a unique CDMA code.

2) FHSS methods that allow MA to be performed at different communication channels, by assigning each touch-input device an individual FH table.

3) THSS methods that allow MA to be performed in different time slots, by assigning each touch-input device an individual TH table.

4) Hybrid models that are any possible combinations of the above MA methods.

3.3.5.2 Tracking Models

Five types of tracking models have been used in this invention to position the touch-input device(s), which include time-delay models, RSS models, experimental models, self-positioning models, and hybrid models.

Time-delay models are based on the fact that the geometry distance, for instance, between the touch position of a touch-input device and a receiver placed in the touch-sensing plane can be determined by a well established mathematical model, depending on the wave field and the propagating medium. For example, when an ultrasound wave field propagating through homogeneous air is used as the physical model, the propagation time is linearly proportional to the distance between the touch point and the receiver. When more than one receiver is used, the 2-D position of a touch-input device can be calculated on this basis.

To obtain the required time-delay estimation of a touch-input device, in this invention the following steps are performed:

1) Use the SS code (e.g., CDMA code, FSHH code, THSS code, etc) of that device to matched-filter the received signal;

2) Obtain the time instant of the matched-filtering output from one information bit in sample precision, and if needed, in sub-sample precision using interpolation between samples;

3) Use an averaging procedure by combining the time instants from different information bits if higher resolution is desired;

4) Use the result from step 3 as the time-delay estimation of this device;

Similarly, the RSS models are also based on the fact that a well-established wave propagation model can be used to determine the geometry between a touch-input device and the receivers, although the model can be more complicated than the time-delay models.

One RSS model used in this invention is the free space propagating model. Consider an RF signal propagating through a free space. Let R be the distance between a touch-input device and a receiver, then in a near-field situation, the RSS of this RF signal is inversely proportional to the square of R, which is:

$$RSS ∝ \frac{1}{{R}^{2}} . \qquad ( 6 )$$

Another RSS model used in this invention is the planar propagating model. That is, when a wave field is confined to propagating through a plane, such as a resistive layer on a touch screen surface through which an EM signal propagates, the associated RSS is then modeled to be linearly proportional to the inverse of R , which is:

$$RSS ∝ \frac{1}{R} . \qquad ( 7 )$$

Using these principles, when more than one receiver is used, a touch-input device can then be tracked. The difference between these two RSS models can be easily understood considering that a signal propagating through a free space such as a sphere will lose more energy than a signal propagating through a plane, so their path loss models are different.

To obtain the required RSS estimation of a touch-input device, in this invention the following steps are performed:

1) Use the SS code (e.g., CDMA code, FSHH code, THSS code, etc) of input device to matched-filter the received signal;

2) Obtain the peak of the matched-filtering output function, namely the RSS, from one information bit. If needed, use an interpolation procedure to find the peak at a higher resolution;

3) Use an averaging procedure by combining the RSSs from different information bits if a higher resolution is desired;

4) Use the result from step 3 as the RSS estimation of this device.

Experimental models (sometimes called calibration models) are established in this invention by taking time-delay and/or RSS measurements, while using one of the specific time-delay or RSS models is optional. One way of establishing an experimental model is to set up a number of calibration points on the surface of a touch-sensing tablet or plane, and take time-delay and/or RSS measurements at these points. A matrix of experimental positioning data can then be established, and touch location resolution can be obtained and/or improved by interpolation using this data.

Self-positioning models in this invention are performed by enabling a touch-input device to do some part of the positioning jobs by itself. For example, a rotary knob may have an electronic-mechanic structure, such as a rotary encoder, to sense the rotary position of the knob. This position may then be sent to the touch screen through a communication channel, so that the touch-sensing tablet can obtain this position information without using any other positioning model.

In this invention, a hybrid model is one of any possible combination of the above models. For example, a time-delay model may be combined with an RSS model to form a hybrid model to achieve a higher touch resolution.

3.3.5.3 Communication Models

Communication models in this invention are fairly straightforward, similar to common SS communication systems known in the prior art. To perform communication procedures, after despreading, a bit decision is made based on the threshold of the despreading output of this bit.

3.3.7 Power Supply for the Device

In this invention, different types of methods to supply power for the active touch-input devices have been developed, which include: 1) using a chemical battery; 2) using a photoelectric battery; 3) using an EM field in free space with an antenna in the active device; 4) using an EM field on a resistive layer; 5) using ultrasound in the air; 6) using ultrasound on the acoustic conductive layer.

Details about the methods 3) -5) can be found in a co-pending patent ______, addressing these issues. It must be noted that, due to the fact that in this invention SS signals are used, an active touch-input device requires much less power than an active device in a narrow band system. This enables the above power supply methods to be more practical.

3.4 System Configuration

In this invention there are two major components to a touch system according to the system design considerations: a hardware platform that physically implements the touch system, and a software structure that performs the system operational functions when data is obtained.

3.4.1 Hardware Platform

The hardware platform of a touch system in this invention can include the configuration of: 1) One or more of the three energy fields (EM, acoustic, and/or light fields); 2) The associated wave propagating media; 3) The transducers that converts the electrical signals into energy field(s) and/or wise visa.; 4) The active and/or passive devices to introduce the touch-input events; 5) The RX/TX Unit to act as the transmission and/or reception chain in the communication channel; 6) the Signal Processing Unit to perform the signal processing needs based on the system operation model used; 7)the Data Processing Unit to perform the data processing procedures such as calibration, data formatting, bit packaging, etc; 8) the Micro-Controller Unit (MCU) to control the overall system operation and the communication with the master PC of the touch screen. FIG. 6 shows the typical hardware configuration of a touch system.

3.4.2 Software Structure

Regarding the building of the software structure, a touch system in this invention can include the development and uses of these programs: 1) to generate the SS signals based on the SS signal structure and the SS code selected; 2) to process the received signals based a pre-defined system operation model, so that the touch-input devices can be identified, tracked, and communicated with; 3) to perform the data processing procedures, such as calibration, data formatting, bit packaging, etc; 4) to perform system control activities.

### BRIEF DESCRIPTION OF THE DRAWINGS

FIGS. 1A and 1B depict signal spectra of narrowband and wideband touch system.

FIGS. 2A-2C depict the information bits, signal structure, and spectrum of a typical DSSS signal

FIGS. 3A and 3B depict examples of frequency hopping in a FHSS system.

FIGS. 4A and 4B depict examples of time hopping in a THSS system.

FIGS. 5A and 5B depict the signal structure and instantaneous frequency of a Chirp signal FIG. 6 is a block diagram of the hardware platform of one embodiment of the touch system of the present invention.

FIG. 7 is a block diagram of the system hardware platform of the one embodiment of the invention.

FIG. 8 is a block diagram of the signal generating portion of an active touch input device of the present invention.

FIG. 9 is a block diagram of a waveform generator for an active touch input device of the present invention.

FIG. 10 is a block diagram of the signal receiving unit according to the present invention.

FIG. 11 is a flowchart depicting the operating routing of a touch input device.

FIG. 12 is a flowchart depicting the signal receiving routine of the touch sensing apparatus.

FIGS. 13A and 13B are a side elevation and top view of a touch input knob controller in accordance with the present invention.

FIGS. 14A and 14B are a top view and a side elevation of a fader controller in accordance with the present invention.

FIGS. 15A and 15B are a side elevation and a top view of a joystick controller in accordance with the present invention.

FIG. 16 is a cutaway side elevation of a pen input device in accordance with the present invention.

FIGS. 17A-17C are illustrations of two CDMA codes and their spectra.

FIG. 18 is a block diagram of a further embodiment of the touch sensor apparatus of the present invention.

FIG. 19 is a system operation flowchart of the embodiment of FIG. 18.

FIGS. 20A-20C are perspective views of a mouse passive input device of the present invention.

FIGS. 21A and 21B are a side elevation and top view of a passive knob controller of the present invention.

FIGS. 22A-22C are side views of three implementations of a passive pen input device of the present invention.

FIGS. 23A and 23B are a top view and perspective view of a fader controller passive input device of the present invention.

FIG. 24 is a perspective view of a joystick controller passive input device of the present invention.

FIG. 25 is circuit schematic of an active pen input device using a chirp signal excitation signal.

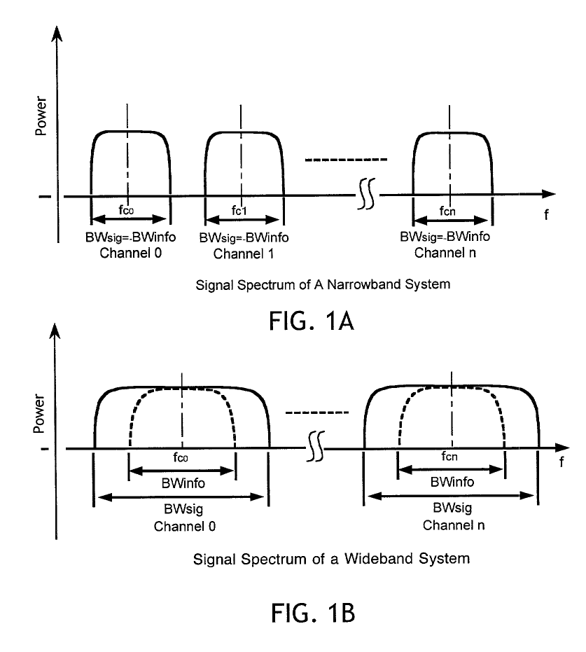

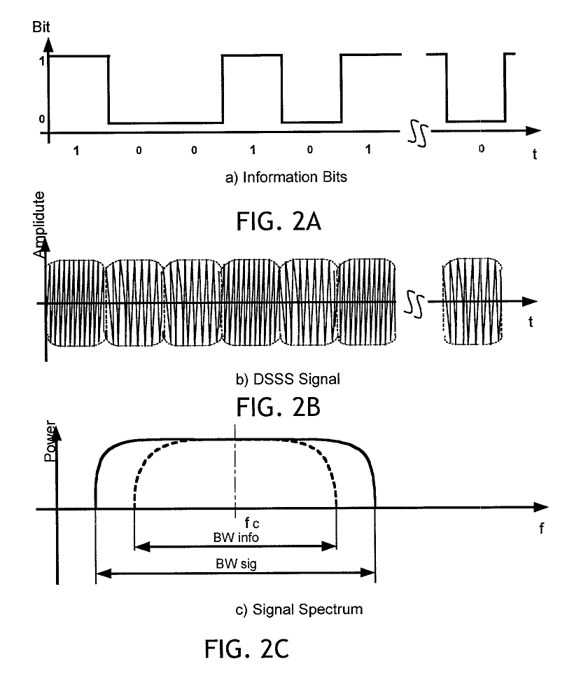

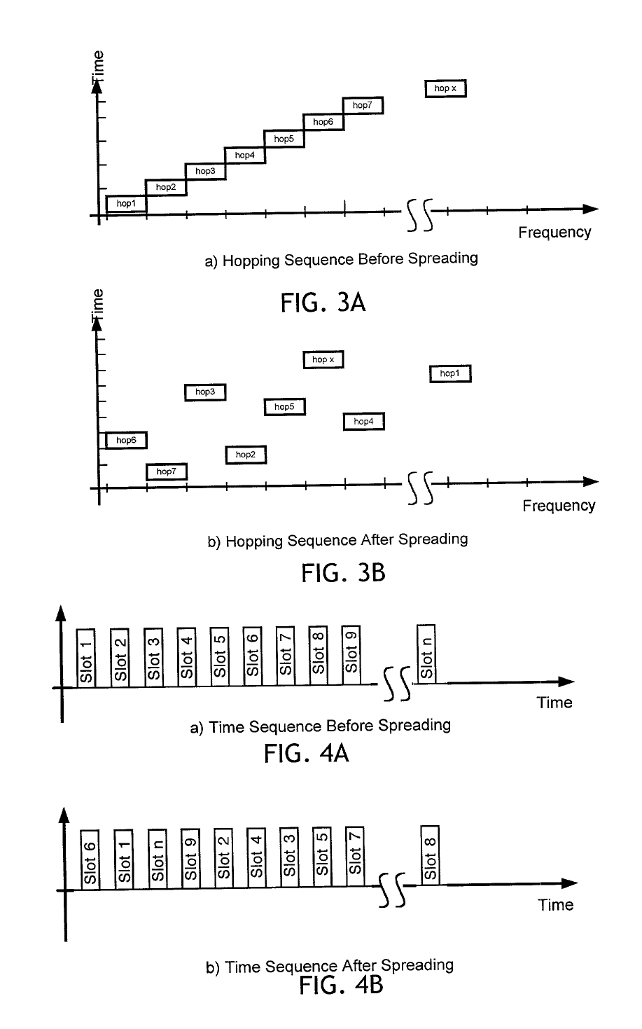

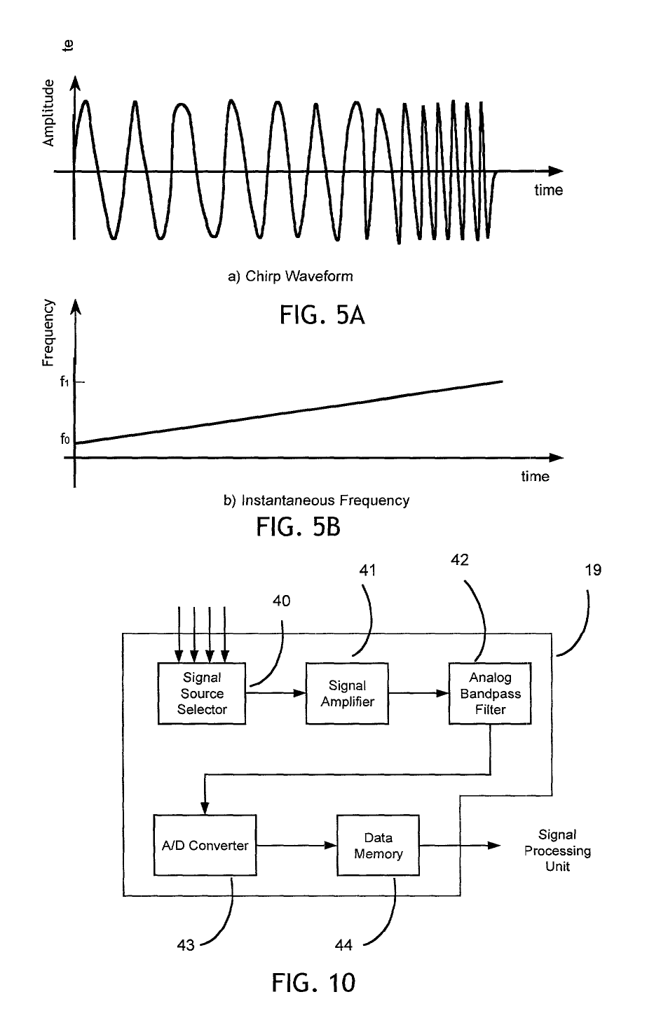

### DESCRIPTION OF THE PREFERRED EMBODIMENT

There are many examples of preferred embodiments in this invention, which are addressed individually as the following:

5.1 Embodiment 1: A Touch Screen for Multiple Active Touch-Input Devices using CDMA SS Signal Structure

The fundamental hardware function blocks of an active touch-input device are illustrated in FIG. 8. This embodiment generally comprises a method and apparatus for tracking one or more active touch-input devices on a touch sensitive surface, using the SS signal structure incorporating CDMA SS codes. Such touch-input devices may include a pen or stylus, knob, slider (fader), switch, joystick, mouse, or its equivalent. One example of an application for this embodiment is to provide a musician with a touch-screen-based mixer/editor platform.

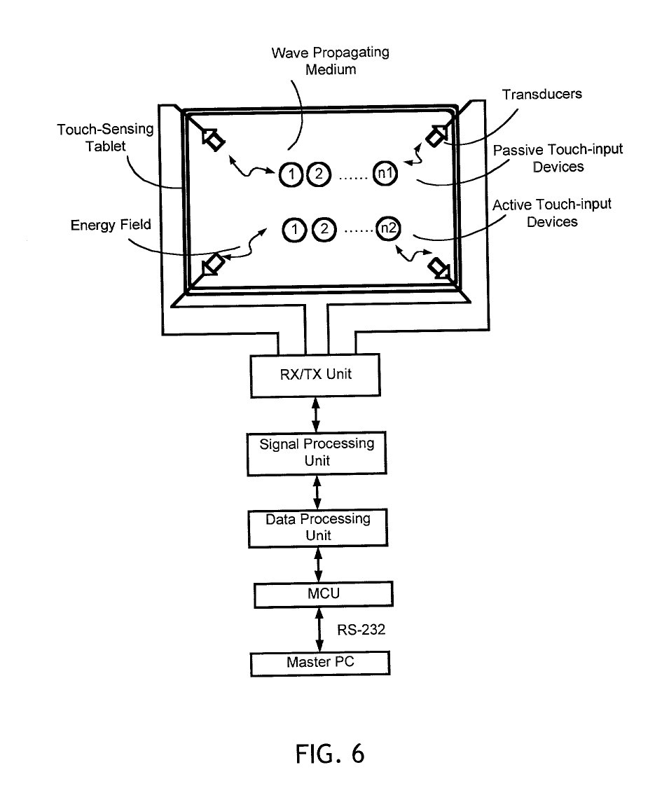

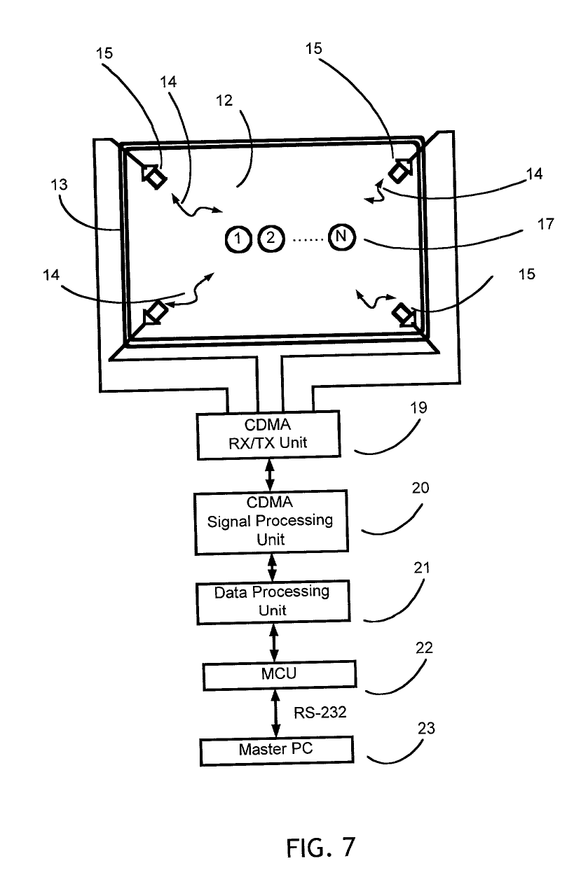

The apparatus of the invention includes at least one, and preferably a plurality of active touch-input devices 17, as shown in FIG. 7. In terms of hardware implementation of the active touch-input devices, they all have generally the same electrical circuitry, with only a small modification according to their specific functionality. In FIG. 8, there is a Power Supply Unit 24 to provide power supply and power control to the device 27. Each touch-input device also includes a CDMA Code ROM 25 and a Waveform Generator 28, which periodically and/or continuously generate communication signals modulated by a unique CDMA code of this device. These CDMA signals are touch-excitation signals that are coupled into the resistive sensing layer 12 by a RX/TX Unit 29 and an EM transducer 30. A Control Unit 31 collects the functional inputs of each device, such as on-off status of switches, etc., and controls all the operational activities of this device.

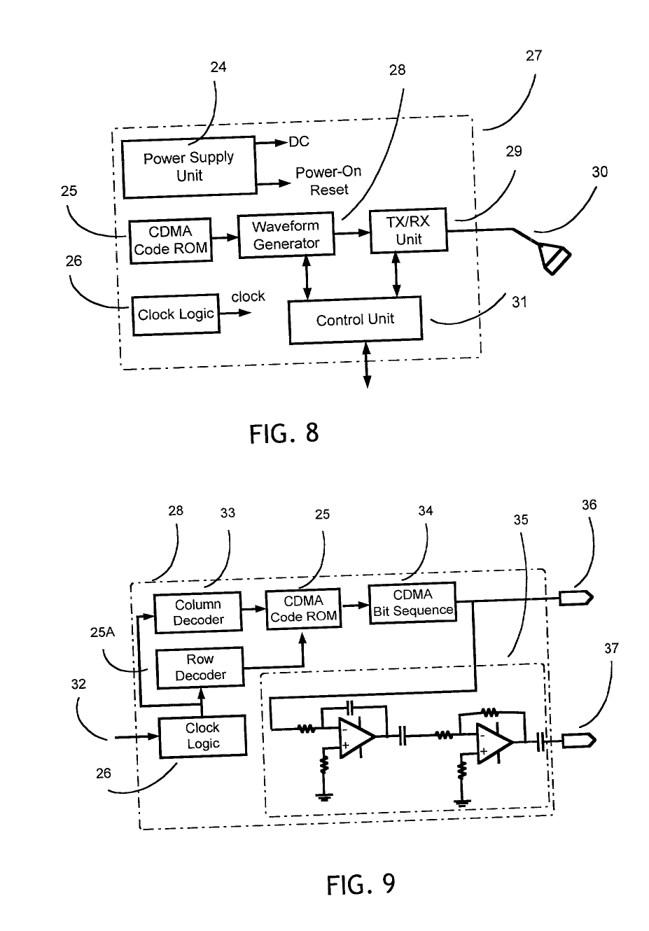

One example of implementing the Waveform Generator 28 in this invention in a cost-effective way, without using an expensive and power-consuming D/A circuit, is illustrated in FIG. 9. The concept of this implementation is first to generate the CDMA signature in square wave then cut off the high order harmonics. As seen from the figure, the Waveform Generator 28 initiates its action by getting a clock signal from an external clock source 32, then a Column Decoder 33 and a Row Decoder 25 A are used to address and fetch a 1-bit data from the CDMA Code ROM 25. When a sequence of this data is clocked out, it forms a CDMA code sequence 34 and is passed through a bandpass filter 35 to cut off the harmonics.

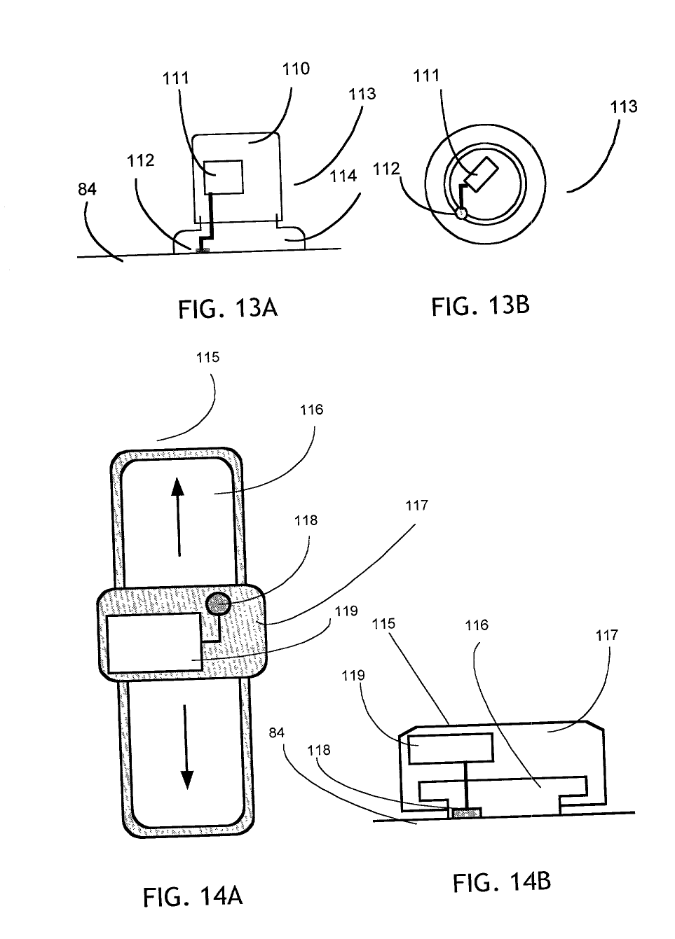

The active touch-input device 17 may take any of several forms that have been disclosed in the prior art. As shown in FIGS. 13A-13B, a knob controller 113 may include a base portion 114, adhered to the sensing surface 84, and upon which is mounted an upper portion 110 adapted for rotation about a common axis. The upper rotatable portion 110 also includes a device circuit 111 and an active touch stimulating tip 112 extending toward the screen layer 84 to emit excitation signals generated by circuit 111, so that the screen assembly detects rotation of the upper portion by identifying the CDMA code and tracking the movement of the tip 112 about the base 114.

With regard to FIGS. 14A-14B, a fader controller (slider) 115 includes an elongated base portion 116 upon which a fader cap 117 is slidable to vary and select values in accordance with the position of the cap along the base. The upper slidable portion also includes a device circuit 119 and an active touch stimulating tip 118 extending toward the screen layer 84, so that the screen assembly detects translation of the upper portion by identifying the CDMA code generated by circuit 119 and tracking the movement of the tip 118 along the base 116.

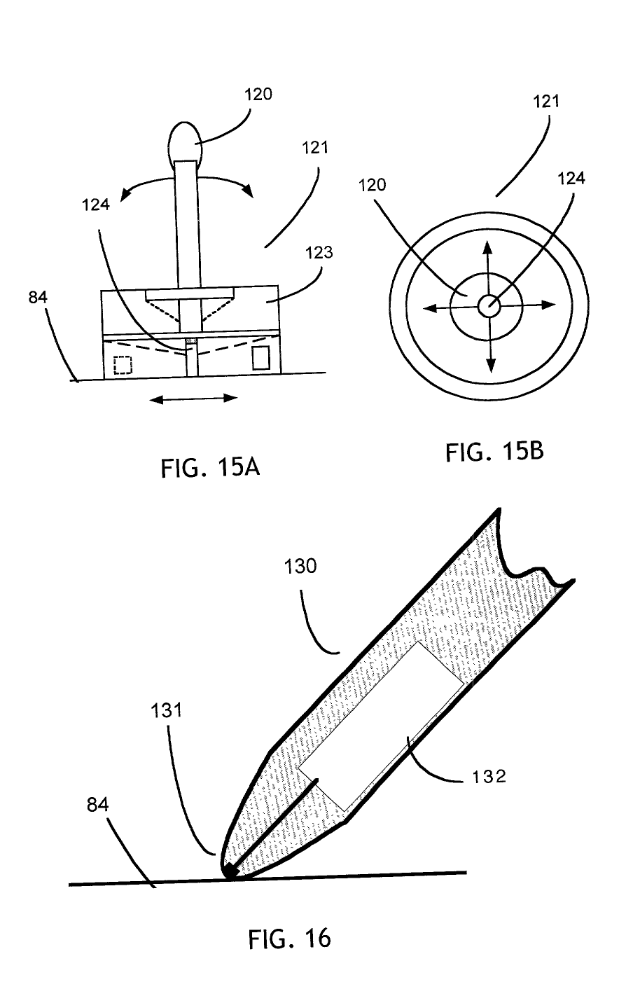

With regard to FIGS. 15A-15B, a joystick controller 121 includes a base portion 123 from which a control wand 120 extends upwardly. The wand 120 is coupled to the active touch stimulating tip 124 extending toward the screen layer 84, so that the screen assembly detects translation of the wand 120 by identifying the CDMA code and tracking the movement of the tip 124 on the screen. The tip movement corresponds to wand motion, whereby highly controllable input signals may be generated. The device 121 may operate in either joystick mode or mouse mode, as explained in the parent application.

With regard to FIG. 16, a further embodiment of the active touch stimulating device is a pen or stylus 130. The pen or stylus may include a signal generating circuit 132 and a tapered contact end supporting the active touch stimulating tip 131 extending toward the screen layer 84 to emit the excitation signal. This arrangement enables the screen assembly to detect and track the movement of the tip 131. The stylus 130 may be wielded in the manner of a pen or pencil to mark or write on the sensing layer 84.

In addition to the active touch-input devices disclosed above, there are also embodiments to perform the system functions, which include the detection of the position of a touch-input device with respect to a sensing surface 13, as shown in FIG. 7. In this embodiment, an EM field 14 propagating through a conductive layer 12 is used as the physical carrier of the information embedded signals between the touch-input devices 17 and the touch-sensing surface 13.

This touch-sensing surface 13 comprises a conductive layer 12 that may be incorporated in a screen assembly, typically (but not necessarily) in combination with a flat panel display, monitor, or other graphic output device. The screen assembly may include a plurality of lamina, and the conductive layer 12 is typically protected by an outer layer of more durable material, such as glass or optical grade plastic material or a durable coating. Alternatively, the conductive layer may be disposed at the back surface of the assembly.

In the preferred embodiment the touch-sensing surface 13 is configured in a familiar rectangular format, though a wide variety of shapes are possible. At each vertex of the surface 13 there is disposed a transducer 15 to send and receive signals from the active touch-input devices 17. The transducers are connected to a CDMA RX/TX unit 19, which does the typical signal transmission and reception jobs of a RX/TX chain in a communication channel, such as A/D, D/A, AGC, power amplification, etc. After signals from touch-input devices are acquired, a CDMA signal processing unit 20 is used to do the necessary signal processing procedures, such as synchronization, matched-filtering, RSS estimation, etc. These results are then passed to a Data Processing Unit 21, to acquire data for the desired system operation, such as device identification, tracking and communication, etc. Finally, this data are transferred to a master CPU controller 22. This data may then be used in a computer system, or any electronic device that may employ a touch screen.

It should be noted that in this embodiment two-way communication between the active touch-input devices and the touch-sensing surface is optional, while one-way communication from a device to the touch-sensing surface can perform the system functions well. This can greatly save the cost of system implementation.

When only one-way communication is concerned, the RX/TX , Unit 19 becomes a data acquisition circuit, an example of which is shown in FIG. 10. This implementation may include a signal source selector 40 to receive the signals from the transducers 15 and process them individually and selectively. The signal from each transducer is a mixture of CDMA signatures from all the active devices operating on the screen. The signals are fed to a signal amplifier 41 and thence to an analog bandpass filter 42 to remove unnecessary noise. The filtered signal is fed to an A/D converter 43 to be converted into digital format and stored in Data Memory 44, ready to be processed by the Signal Processing Unit 20.

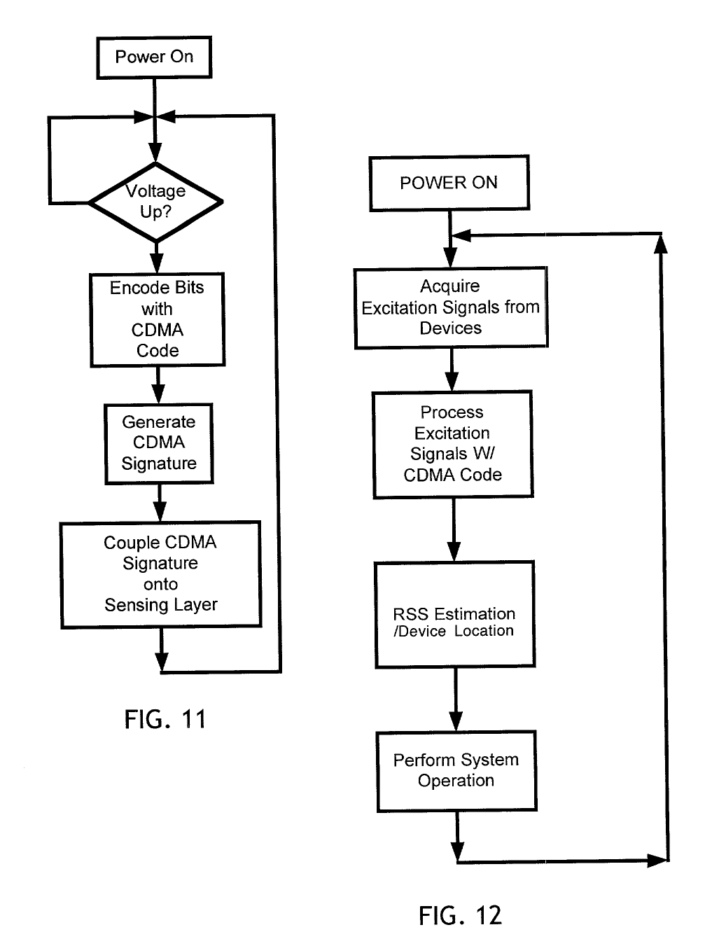

The operation flowchart of an active touch-input device is illustrated in FIG. 11. After power up, the device first checks for related input status. Then, this status, together with other positioning information bits, are encoded into CDMA signatures using the CDMA code for this device. These signatures are then passed through a bandpass filter and then delivered to the touch-sensing surface 12, completing the touch-excitation procedure.

The operation flowchart of the touch-sensing architecture is illustrated in FIG. 12. After power up, the system looks for excitation signals from whatever active touch-input devices 17 are currently operating with the screen assembly 13. These signals are processed to determine their respective CDMA codes, and subsequently the position of each device 17 is determined. This data is transmitted from the CPU 22 to the computer system (or equivalent) that is associated with the touch screen assembly 13.

In this embodiment, a linear RRS model is used to calculate the position of each touch-input device. It is noted that the conductive layer 12 (FIG. 12) comprises an impedance that is distributed uniformly in the plane of the layer. The signal of each active touch stimulating device 17 is received by all of the transducers 15, and the strength of each received signal is directly related to the distance from the active touch stimulating tip on the layer 12 to each of the transducers 15. After matched-filtering the received signals with the CDMA code from each touch-input device, the RSS of that device can be determined. Calculations may then be carried out to determine the active touch stimulating position relative to the transducers 15, and thus to a X-Y coordinate system. In this fashion a plurality of active touch stimulating devices may be tracked concurrently.

To identify the presence of a touch-input device, if the RSS of that device exceeds a preset threshold, it is recognized to be operating on the screen. Thereafter, the determination of the touch stimulating device location is carried out based on RSSs obtained from different transducers. As is known in the prior art, the RSS is proportional to the distance from each active touch-input device to each transducer, and the position data for each active touch-input device may be calculated from ratios of the RSS data from each transducer.

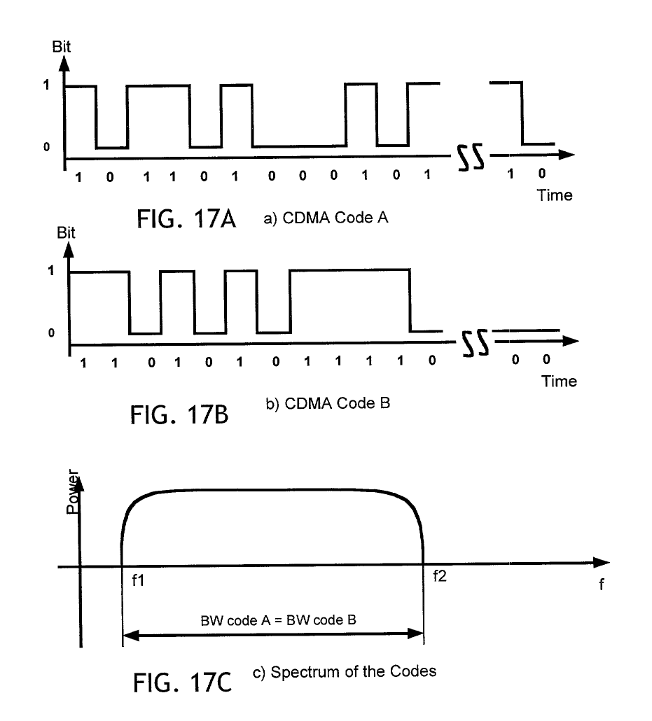

The RSS position locating arrangement of the invention is facilitated by the use of CDMA signals regarding their orthogonality. As shown in FIGS. 17A-17B, two examples of CDMA codes of active touch stimulating device signals, CDMA code A and CDMA code B, are comprised of binary bits in series. These two codes occupy the same spectrum, which goes from f₁-f₂ and is fairly flat across the entire bandwidth. Generally speaking, the number of ones and zeros in a CDMA code are approximately equal and evenly distributed in time so that the spectrum is generally flat.

CDMA methodology has been used for wireless communications by military organizations to encode communications information so that the carrier appears to be noise, and thus to be difficult to detect and intercept. CDMA systems operate with high reliability in noisy environments, yet require relatively low power and have relatively high data rates. In this invention, CDMA methodology is used in several unique ways:

1) The system may use only one-way communications from the active touch stimulating device(s) to the screen assembly, rather than two-way communications of prior systems;

2) Once the RSS is obtained, it is used for both device detection and tracking. In typical CDMA communications systems, RSS is used only for detection.

3) This invention uses the sensing layer 12 as the signal propagation medium, rather than a broadcast EM field used in wireless CDMA communications. The sensing layer as a propagation medium enables the linear RSS model for the positioning of the system.

4) The number of active touch stimulating devices may be one, or more than one, depending on the needs of the user.

There are known in the prior art many methods for generating CDMA coded transmissions. One technique involves using Walsh functions to generate CDMA codes according to the channel bandwidth of the system. Another process is to generate a white noise signal, and then store it as a CDMA code. Any CDMA code generating method known in the prior art may be used in this invention.

With reference to FIG. 8, the entire circuitry for an active touch stimulating device may be embodied in one custom ASIC 27 having approximately 2000 gates or less. That is, the Power Supply Unit 24, the Clock Logic 26, the CDMA code ROM 25, the Waveform Generator 28, and the Control Unit 31, and the RX/TX Unit 29 may all be formed in one ASIC, thereby minimizing the device size and enabling a device of small dimensions. The use of a custom ASIC also makes the active touch stimulating devices more rugged by reducing component connections, and it minimizes power consumption.

It should be noted that the screen assembly of this embodiment is also capable of being combined with components that register a finger touch. A finger touch typically acts to capacitively couple to the sensing layer the body attached to the touching finger. Current is drawn from the sensing layer of the screen assembly, and current flow from each of the signal pickups may be determined and calculations made to locate the finger touch on the screen. Another method for combining the finger touch with the CDMA coded active touch stimulating arrangement is to assign the CDMA to a bandwidth that does not interfere with the noise bandwidth coupled to the screen sensing layer by the finger touch.

5.2 Embodiment 2: An Acoustic Wave Touch Screen with Multiple Passive Touch-Input Devices

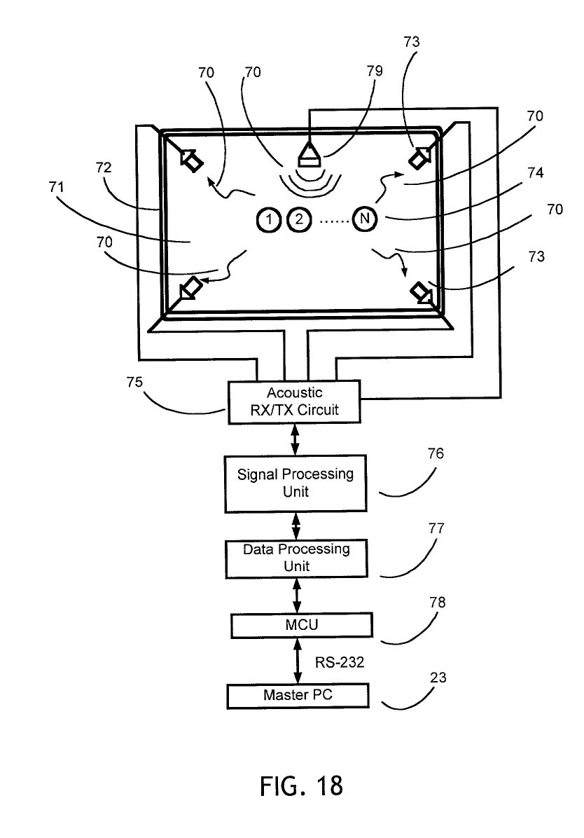

The acoustic wave touch detection system of this embodiment is illustrated in FIG. 18.This embodiment generally comprises a method and apparatus for tracking one or more passive touch-input devices on a display surface and/or touch sensitive surface, using a SS signal structure. Such touch-input devices may include a pen or stylus, knob, slider (fader), switch, joystick, mouse, or the equivalent. Typical applications of this embodiment include using it as a computer touch-screen, a digitizer, a writing pad, a mouse pad, a computer-game input apparatus such as joysticks, etc.

The apparatus of the invention includes at least one, and preferably a plurality of passive touch-input devices 74. One common feature of these passive touch-input devices is that they have one or more acoustic reflectors, and are devoid of any internal electronic components. These reflectors are used as the signal sources of each touch-input device.

In the configuration, an acoustic wave field 70 propagating through air 71 is used as the physical carrier of the communication between the passive devices and the touch-sensing apparatus. In the system, an acoustic transmitter 79 and an RX/TX circuit 75 are used to generate the SS signal carrying acoustic wave field 70, which is distributed across the surface of the display 72. When a passive touch-input device 74, such as a passive knob 86 (FIG. 21A-21B) with positioning reflector(s) 83, is placed within this field, it will reflect the SS signals transmitted from the transmitter 79. These reflected SS signals, termed echoes, are picked up by the acoustic receivers 73 placed on the surface of the display 72 (this surface could be the surface of a touch screen), and amplified and filtered by an acoustic RX/TX circuit 75. These echoes are then processed by a Signal Processing Unit 76, using time-delay models, to track the position of the passive device. Finally, the system operational results are processed by a Data Processing Unit 77 and a MCU 78 is used to build up the data communication between the touch sensing system and the master PC 23.

It should be noted that in FIG. 18 the number of the transmitter and receivers, as well as their placement geometry, are for illustration only. Exact configuration may vary from one embodiment to another. For example, in one embodiment of a touch-screen for computers, the configuration could be a transmitter placed at the middle of one side and two receivers which are placed at the two top corners of the screen, respectively. In another embodiment of a square-shaped digitizer, the transducer configuration could be two transmitters at the middle of the right-hand and left-hand sides, and four receivers at the corners, respectively.

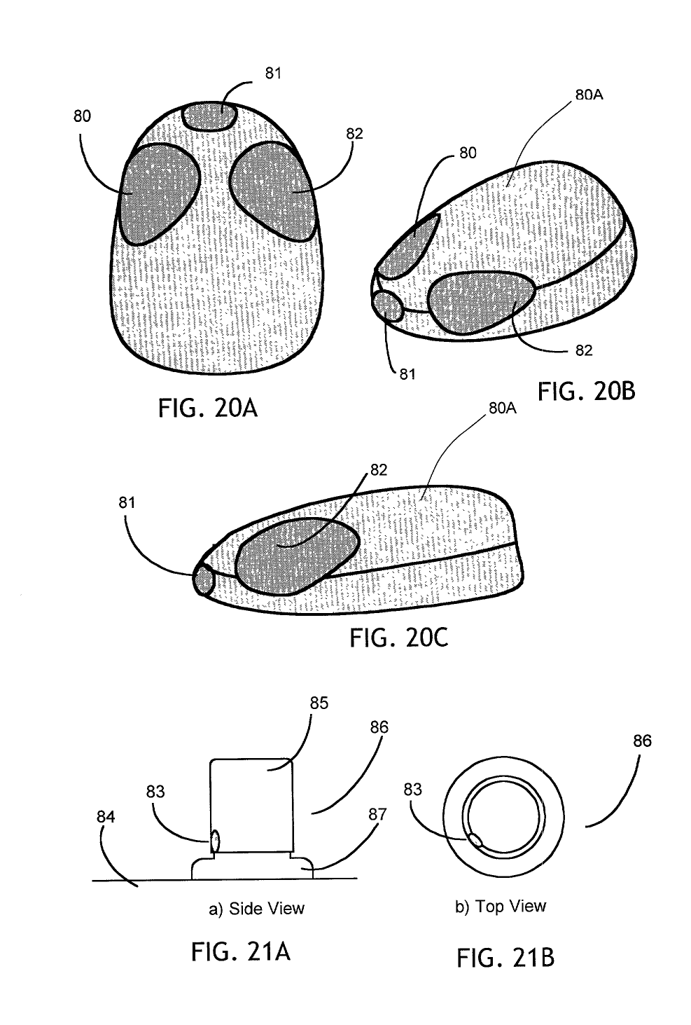

The passive touch-input devices 74 may have different implementations according to their specific functional requirements. As shown in FIGS. 20A-20C, a passive mouse 80A may have 3 reflectors to perform its function. The positioning reflector 81 is fixed in the middle of its front to yield its position information, two other reflectors, the right button 82 and the left button 80, are designed as moveable buttons to yield the clicking status. Positioning resolution of these 3 reflectors may be designed to be different due to their different functionality.

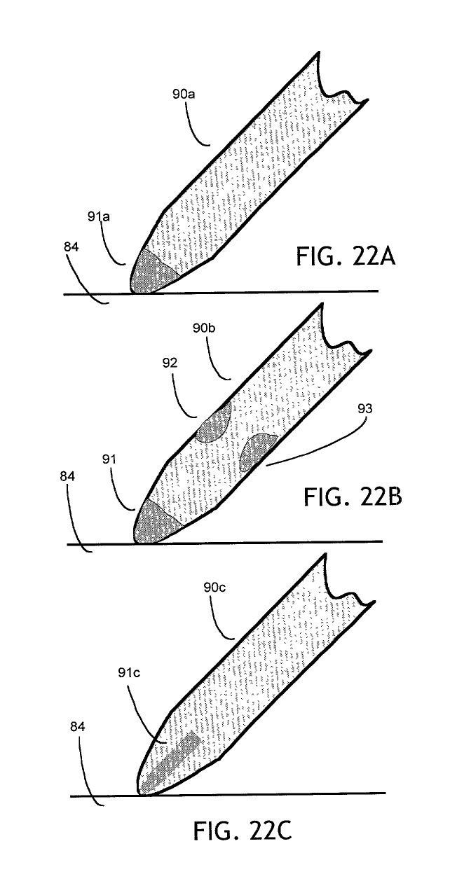

As shown in FIG. 22A, a regular pen or stylus 90a may have only one positioning reflector 91a to perform its function as a pen to write on the touch-sensing tablet. A mouse-pen 90b (FIG. 22B) may have two more reflectors, right button 92 and left button 93, to function as a pen as well as a mouse. Referring to FIG. 21, a knob controller 86 may include a base portion 87 upon which an upper portion 85 that is mounted for rotation about a common axis. The upper rotatable portion also includes a positioning reflector 83, so that the touch-sensing apparatus can detect the position and rotation of the upper portion by tracking this reflector.

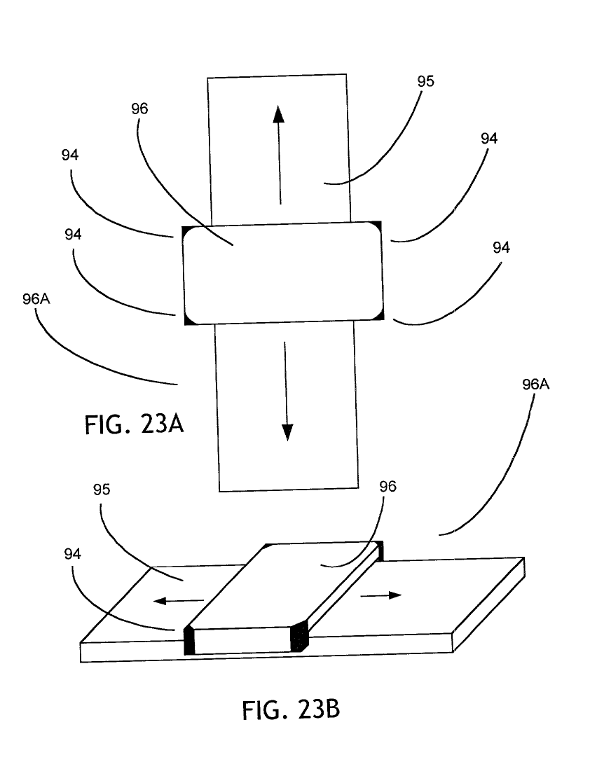

With regard to FIGS. 23A-23B, a slider (fader) controller 96 A may have two portions in its structure. The base portion (fader track) 95 is adhered to the touch-sensing surface stage when the slider is in use and the sliding portion (fader cap) 96 can move along the fader track. On the fader cap, in order not to be covered by the operator's finger, four positioning reflectors 94 are used to tell the relative position of the fader cap along the fader track. The system can automatically choose one of the reflectors 94 to do the positioning.

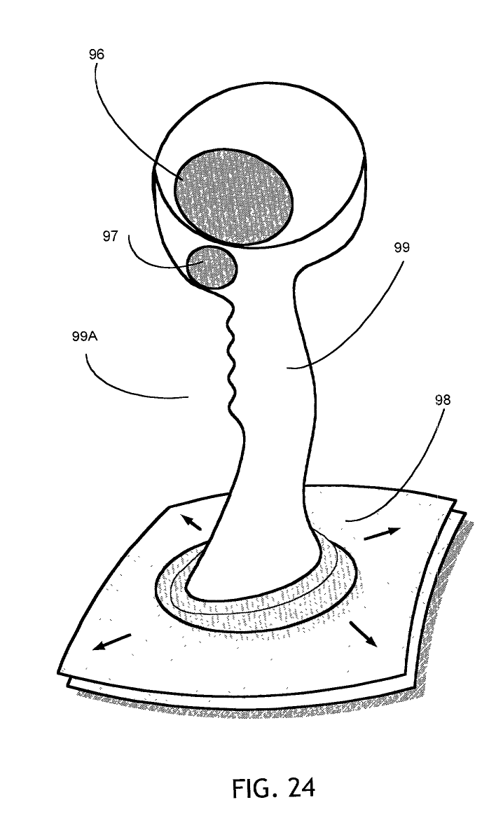

With regard to FIG. 24, a joystick 99 A may also have two portions in its structure. The base portion 98 is fixed to a place near the touch-sensing tablet when the joystick is in use and the handle 99 can make 3-D movements on this base. A positioning reflector 97 is used to sense the 3-D movement of the handle and a fire-button reflector 96 is used to simulate the fire operation.

It should be noted that, as air is used as the propagating medium, the acoustic wave is not confined to the surface of the touch-sensing tablet, and also not confined to a 2-D plane. That is to say, with a proper transducer orientation arrangement, in this embodiment the system can perform 3-D positioning of the passive touch-input devices.

For example, suppose a touch screen system is designed to have a passive joystick 99A as one of its touch-input devices. Then the transducers could have their TX/RX beam patterns, the effective coverages of directional transducers, to cover the computer screen surface, as well as a 3-D space within 1-2 meters from the screen. The joystick 99 A with passive reflectors 96 and 97 can be placed anywhere within the acoustic wave covered space to perform its functions. The touch system can perform 2-D positioning for the touch-input devices on the screen surface, such as a pen 90a and a knob 86, and 3-D positioning of the devices outside the screen surface, such as a joystick 99A and a wireless mouse 80A.

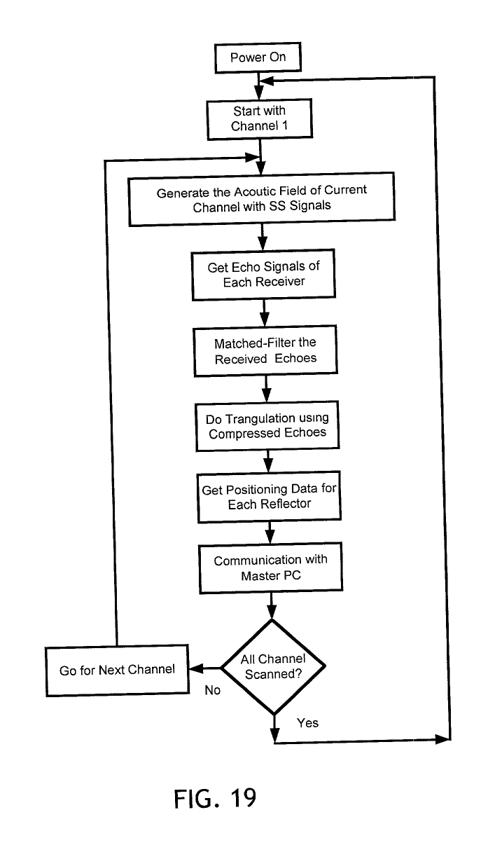

In this embodiment, as seen from FIG. 19, the system operation is identical for each acoustic channel, which the reflectors of different passive touch-input devices may be assigned to. The ability to distinguish multiple touch input devices can be accomplished by many methods. One example is to use reflectors that have a unique reflectivity which responds to certain frequencies. For instance, one type of reflector may have very great reflectivity at one frequency but not at other frequencies and another reflector may have very great reflectivity at another frequency that is clearly distinguishable from the first reflector's frequency and so on. Another example is to use the 2-D and/or 3-D modeling ability of this system. This modeling capability enables the system to distinguish multiple devices that have been placed in different positions on the touch sensing area.

Multiple reflectors can be used on a single device where each reflector is distinguishable from the others. One method to do this is to use 3-D modeling to distinguish multiple reflectors utilized on a single device, i.e., a mouse or pen, where all of the reflectors on this device respond to the same frequency, but each individual reflector is distinguishable from each other by knowing the position of each reflector in 3-D space. As shown in FIGS. 20A-20C and FIG. 22B, the buttons 80-82 and 92-93 may comprise depressable surfaces, and their movement, when depressed, is detectable by the 3-D modeling system and converted to button commands. Arrangements in the prior art for forming depressable buttons are widely known and widely diverse.

For the operation at each channel, the system first generates an acoustic wave field by periodically transmitting a SS code, such as a Chirp, across the touch-sensing surface. Echoes from the reflectors within this field are then collected by the receivers placed in a preset geometry. These recorded echoes are matched-filtered with the transmitted SS code to obtain the matched-filtered echoes, which are also called compressed echoes in that they are compressed in time. Using the receiver geometry and the time instants of the peaks in the compressed echoes, the locations of the reflectors can then be identified. This positioning data is then passed through the master PC for further processing.

Time-delay positioning models based on acoustic wave technology have been widely used in both military and civilian applications for more than 100 years. The first patent regarding this technique can be traced to methods of detecting the range of underwater icebergs, after the tragedy of Titanic shocked the world. Since then SONAR (Sound Navigation and Ranging) and RADAR (Radio Detection And Ranging) have been developed with a variety of applications, most of which are based on time-delay models. Some times methods developed for either sonar or radar can be applied to each other without major modifications, after acquiring signals from their individual RX/TX front ends.

In this embodiment, the following aspects are believed to be unique compared to current touch-screen technologies:

1) Time-delay models, instead of RSS models, are used. This yields higher resolution due to the relatively easy-to-achieve high resolution in time-delay estimation of the acoustic signal.

2) No sensing layer is required for approaches where air can be used as the propagating medium.

3) SS signal structures are used to eliminate multi-path, a severe problem in narrow band systems.

4) Passive devices can be used, so the devices can be very low cost.

5) The touch receiving system can be low cost because no special sensing layer is required.

6) Transducers can be placed anywhere near the display's surface and/or a touch screen. As devices are placed on or near a display, calibration procedures can be used to locate and enable the operation of these transducers at any location. Transducers are not confined to a preset place or geometry.

7) Touch-input devices can be used to trigger touch-input events anywhere in a 3-D space near the touch sensing-tablet. There is sufficient resolution in 3-D spatial resolution to detect the actuation of control buttons (mouse buttons, pen buttons, joystick buttons, etc.). Such devices are not confined to a preset place or geometry.

8) More advanced and well-developed signal processing methods based on time-delay models can be utilized to increase the positioning accuracy (touch resolution) of any device.

9) Using Spread Spectrum technology, MA can be realized for passive devices by assigning different frequency bands to different devices.

5.3 Embodiment 3: A Touch Screen with A Passive Touch-Pen

This embodiment can be generally regarded as a simplified version of embodiment 2, where the touch-input devices are limited to a single passive touch-input pen 90c, as shown in FIG. 22C.

In this embodiment, the touch-input pen 90c is a passive pen which can be made by putting a small acoustic reflector 91c at the lower part of a stylus. With the regular functionality disclosed in the embodiment 2, this pen can function as an touch-input pen to perform the system functions such as touch-and-select, writing, etc.

Combined with the embodiment disclosed in companion patent application Ser. No. ______, filed ______, the passive touch-input pen 90c can be used to operate a graphic knob controller (an emulated graphic knob on a display). By placing the pen over the approximate center of a graphic image of a knob on a display and twisting the pen between one's fingers, the graphic knob can be rotated and thereby be used as a physical controller. As disclosed in embodiment 2 of this invention, 3-D position data of the reflector on the touch-input pen can be acquired by the touch system. This data can be then post-processed by the system of this invention to obtain further information such as rotary angle, moving speed, rotary axis, etc. This information is then used to operate the graphic knob-controller.

In short, the passive touch-input pen 90c in this embodiment can be used as a stylus, as well as a physical knob-controller, due to the 3-D positioning capability of the touch-input system.

The advantage of this embodiment, as compared to embodiment 2, is its simplicity in hardware. As there is only one touch-input device, the system hardware configuration, such as RX/TX chain, MIPS requirement, could be very simple. A product example of this embodiment would be very low-cost touch-screens for computers, palm computers, high end cell phones, etc.

5.4 Embodiment 4: A Touch Screen with An Active Touch-Pen

This embodiment can be generally regarded as a simplified version of the embodiment of FIG. 6, where the touch-input devices are limited to a single active touch-input pen 130, and the excitation signals are not limited to CDMA signal structures.

In this embodiment, the touch-input pen 130 (FIG. 16) is an active pen which can emit an excitation signal with an SS signal structure. This excitation signal can be used to track the touch-position of the pen when the pen touches the touch-sensing tablet to introduce a touch event. In the instance where there is only one touch-input device allowed by the touch system, no MA method would be required. The excitation signal could take the form of one of any of the available SS signal structures, such as a Chirp signal. This allows the pen to have maximum freedom in hardware configuration, while the advantage of using an SS signal structure remains unchanged.

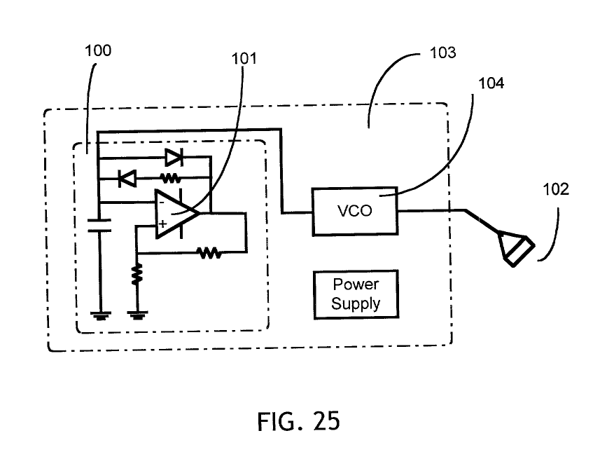

For example, to generate a SS signal in analog output form, in some cases a Chirp signal could be much more easily generated than a CDMA signal. FIG. 25 is an example of the circuit used in the pen. In this figure, a comparator 101 is used to form a multivibrator 100 to generate a voltage increased by time. This voltage is then used to control the frequency of the VCO (Voltage-Controlled-Oscillator) 104. The output of the VCO is then an analog Chirp signal, which is coupled by the EM transmitter 102 (a capacitor, for example) onto the touch-sensing layer. Since a Chirp signal that is generated in this manners has less harmonic distortion than the CDMA signals generated using the circuit 27 disclosed in FIG. 8, a higher effective PG for the Chirp can be expected. This embodiment can also be combined with the embodiment disclosed in the patent application Ser. No. 09/139,078, filed Aug. 24, 1998, addressed above. The touch-input pen can be used to operate a graphic knob controller, in a way similar to the mouse disclosed in that patent application. However, here in this embodiment there are some improvements. With the more accurate 2-D positioning of the pen tip using a SS signal structure (and the handy drawing capability of using a pen), this operation becomes much easier and more accurate.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiments described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A touch sensing system for identifying and locating one or more touch stimulating devices in a touch sensing area, including:
a signal propagating medium for conducting signals throughout said touch sensing area;
at least one of said touch stimulating devices including means for producing a touch excitation signal and coupling said signal to said propagating medium, said touch excitation signal comprising a spread spectrum signal;
each touch excitation signal including a unique code identifying the respective device;
signal pickup means associated with said sensing area and connected to said propagating medium to receive at least one touch excitation signal from said one or more touch stimulating devices;
means for decoding said touch excitation signal to identify at least one of said touch stimulating devices;

2. The touch sensing system of claim 1, further including means for determining the position of at least one of said touch stimulating devices in said touch sensing area.

3. The touch sensing system of claim 1, wherein said one or more touch stimulating devices are passive devices.

4. The touch sensing system of claim 3, further including means for generating an energy field in said propagating medium within said touch sensing area.

5. The touch sensing system of claim 4, wherein said energy field includes a spread spectrum signal component.

6. The touch sensing system of claim 4, wherein each of said touch stimulating devices includes at least one reflector adapted to reflect a portion of said energy field.

7. The touch sensing system of claim 6, wherein said signal pickup means includes means for receiving a reflected signal from said at least one reflector.

8. The touch sensing system of claim 4, wherein said energy field includes an EM field.

9. The touch sensing system of claim 8, wherein said propagating medium comprises free space in said touch sensing area.

10. The touch sensing system of claim 8, wherein said propagating medium comprises a conducting layer in said touch sensing area.

11. The touch sensing system of claim 4, wherein said energy field includes an acoustic wave field.

12. The touch sensing system of claim 11, wherein said propagating medium comprises free space in said touch sensing area.

13. The touch sensing system of claim 11, wherein said propagating medium comprises an acoustic conducting layer in said touch sensing area.

14. The touch sensing system of claim 4, wherein said energy field includes a light wave field.

15. The touch sensing system of claim 14, wherein said propagating medium comprises free space in said touch sensing area.

16. The touch sensing system of claim 14, wherein said propagating medium comprises a light conducting layer in said touch sensing area.

17. The touch sensing system of claim 7, wherein said signal pickup means includes a plurality of spaced apart signal pickups, and said means for determining the position of each of said one or more touch stimulating devices includes means for calculating the time delays of said reflected signals passing through said propagating medium to said plurality of signal pickups.

18. The touch sensing system of claim 7, wherein said signal pickup means includes a plurality of spaced apart signal pickups, and said means for determining the position of each of said one or more touch stimulating devices includes means for calculating the received signal strengths of said reflected signals passing through said propagating medium to said plurality of signal pickups.

19. The touch sensing system of claim 5, wherein said spread spectrum signal component includes at least one of the following signal types: direct sequence spread spectrum, frequency hopping spread spectrum, time hopping spread spectrum, and linear frequency sweeping signals.

20. The touch sensing system of claim 1, wherein said unique codes of said one or more touch stimulating devices are orthogonal codes.

21. The touch sensing system of claim 1, wherein said one or more touch stimulating devices are active devices that generate a touch excitation signal.

22. The touch sensing system of claim 21, wherein said touch excitation signal is an EM signal.

23. The touch sensing system of claim 22, wherein said propagating medium comprises free space in said touch sensing area.

24. The touch sensing system of claim 22, wherein said propagating medium comprises an EM conducting layer in said touch sensing area.

25. The touch sensing system of claim 21, wherein said touch excitation signal is an acoustic wave signal.

26. The touch sensing system of claim 25, wherein said propagating medium comprises free space in said touch sensing area.

27. The touch sensing system of claim 25, wherein said propagating medium comprises an acoustic conducting layer in said touch sensing area.

28. The touch sensing system of claim 21, wherein said touch excitation signal is an light wave signal.

29. The touch sensing system of claim 28, wherein said propagating medium comprises free space in said touch sensing area.

30. The touch sensing system of claim 28, wherein said propagating medium comprises a light conducting layer in said touch sensing area.

31. The touch sensing system of claim 21, wherein said signal pickup means includes a plurality of spaced apart signal pickups, and said means for determining the position of each of said one or more touch stimulating devices includes means for calculating the time delays of said excitation signals passing through said propagating medium to said plurality of signal pickups.

32. The touch sensing system of claim 21, wherein said signal pickup means includes a plurality of spaced apart signal pickups, and said means for determining the position of each of said one or more touch stimulating devices includes means for calculating the received signal strengths of said excitation signals passing through said propagating medium to said plurality of signal pickups.

33. The touch sensing system of claim 21, wherein said means for decoding and identifying each of said one or more touch stimulating devices includes matched-filtering means for comparing received touch excitation signals to stored spread spectrum codes of said one or more devices.

34. The touch sensing system of claim 1, wherein said at least one touch stimulating device comprises a joystick controller.

35. The touch sensing system of claim 1, wherein said at least one touch stimulating device comprises a mouse controller.

36. The touch sensing system of claim 1, wherein said at least one touch stimulating device comprises a knob controller.

37. The touch sensing system of claim 1, wherein said at least one touch stimulating device comprises a fader controller.

38. The touch sensing system of claim 1, wherein a portion of said one or more touch stimulating devices are active devices that generate a touch excitation signal, and another portion of said one or more touch stimulating devices are passive devices.

39. A touch sensing system for identifying and locating one or more touch stimulating devices in a touch sensing area, including:
a signal propagating medium for conducting signals throughout said touch sensing area;
at least one of said touch stimulating devices including means for producing a touch excitation signal and coupling said signal to said propagating medium, said touch excitation signal comprising a spread spectrum signal;
each touch excitation signal including a unique code identifying the respective device;
signal pickup means associated with said touch sensing area and connected to said propagating medium to receive at least one touch excitation signals from said one or more touch stimulating devices;
means for decoding said touch excitation signals to identify said one or more touch stimulating devices; and,
means for determining the position of said one or more touch stimulating devices in said touch sensing area.

40. The touch sensing system of claim 39, wherein said at least one touch stimulating device comprises a joystick controller.

41. The touch sensing system of claim 39, wherein said at least one touch stimulating device comprises a mouse controller.

42. The touch sensing system of claim 39, wherein said at least one touch stimulating device comprises a knob controller.

43. The touch sensing system of claim 39, wherein said at least one touch stimulating device comprises a fader controller.

44. The touch sensing system of claim 39, wherein a portion of said one or more touch stimulating devices are active devices that generate a touch excitation signal, and another portion of said one or more touch stimulating devices are passive devices.
